(19) United States
(12) Patent Application Publication
(10) Pub. No.: US 2026/0242228 A1
(43) Pub. Date: Aug. 20, 2026

(54) CATION-INTERCALATED MXENE, AND METHOD OF MANUFACTURING THE SAME

(71) Applicant: KOREA INSTITUTE OF SCIENCE AND TECHNOLOGY, Seoul (KR)

(72) Inventors: Seon Joon KIM, Seoul (KR); Tae Gon OH, Seoul (KR); Albert LEE, Seoul (KR); Ju Yun LEE, Seoul (KR); Sung Ho CHO, Seoul (KR)

(73) Assignee: KOREA INSTITUTE OF SCIENCE AND TECHNOLOGY, Seoul (KR)

(21) Appl. No.: 19/646,648

(22) Filed: Apr. 14, 2026

Related U.S. Application Data
(63) Continuation of application No. PCT/KR2025/015240, filed on Sep. 26, 2025.

(30) Foreign Application Priority Data
Feb. 4, 2025 (KR) 10-2025-0013546

(51) Int. Cl. C01B 32/914; C01B 21/06

(52) U.S. Cl. CPC C01B 32/914; C01B 21/06; C01P 2002/08; C01P 2002/72; C01P 2002/84; C01P 2004/02; C01P 2004/20; C01P 2006/40

(57) ABSTRACT

A cation-intercalated MXene comprises: MXene nanoparticles intercalated with a cation, wherein the MXene nanoparticles are representable in a MXene solution when dissolved in a solvent, wherein MXene nanoparticles of the MXene solution are represented by the following Chemical Formula 1,

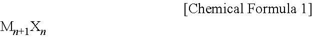

wherein, M is a transition metal element selected from the group consisting of Sc, Ti, V, Cr, Mn, Y, Zr, Nb, Mo, Hf, and Ta, X is at least one of carbon and nitrogen, and n is an integer of 1 to 4.

### CROSS REFERENCE TO RELATED APPLICATION

Pursuant to 35 USC 120 and 365(c), this application is a continuation of International Application No. PCT/KR2025/015240 filed on Sep. 26, 2025, and claims the benefit under 35 USC 119 (a) of Korean Application No. 10-2025-0013546 filed on Feb. 4, 2025, in the Korean Intellectual Property Office, the entire disclosure of which is incorporated herein by reference for all purposes.

### BACKGROUND OF THE DISCLOSURE

### Field of the Disclosure

The present disclosure relates to a method of preparing a cation-intercalated MXene solution by adding a metal cation or an organic cation containing nitrogen to a MXene solution, and drying the same to obtain a solid-phase form, and then dissolving the same in a redispersion solvent to prepare a redispersed MXene solution.

### Description of the Related Art

MXene is a ceramic material having a two-dimensional planar structure in which carbon or nitrogen is bonded to a transition metal. A process of converting a three-dimensional MAX phase into a two-dimensional MXene involves an etching process using a strong acid. As a result of the etching process, functional groups such as hydroxyl groups (OH) and oxide groups (—O) remain on a surface of the MXene. Accordingly, MXene has attracted attention as a material having electrical conductivity due to a transition metal while also having hydrophilicity due to functional groups present at terminals.

In particular, MXene has strong hydrophilicity and thus has a characteristic of being stably well dispersed in water. Accordingly, MXene has attracted attention as an ideal material to be utilized as a conductive ink in a solution form.

Since a synthesis process of MXene is performed in an acidic aqueous solution environment, the MXene is inevitably obtained in a form dispersed in an aqueous solution. However, in order to industrially utilize a MXene material widely, there is a reason to dry the MXene to make the same into a solid form such as a powder. First, since MXene is easily oxidized in an aqueous solution environment, MXene loses its inherent high electrical conductivity. Second, in order to apply mass production technology to MXene and to enable smooth material utilization between industries, it is efficient and economical to use a powder form that is lighter than a solution.

Accordingly, it is possible to convert an aqueous MXene solution into a solid form such as a MXene powder by using methods such as thermal drying or freeze drying. However, when the dried MXene powder is re-dispersed in a solvent, there is a fatal disadvantage in that a redispersion efficiency is low. This occurs because when relatively inflexible MXene nanoparticles are strongly bonded by van der Waals forces after drying, solvent molecules are unable to separate the MXene nanoparticles again.

### SUMMARY OF THE DISCLOSURE

An object of the present disclosure is to provide a cation-intercalated MXene and a method of manufacturing the same, in order to solve the above-described problems.

In addition, an object of the present disclosure is to provide a dried solid-phase MXene and a method of manufacturing the same, obtained by manufacturing the cation-intercalated MXene solution and then drying the same, in order to solve the above-described problems.

In addition, an object of the present disclosure is to provide a redispersed MXene solution in which a solid-phase MXene is redispersed, and a method of manufacturing the same, in order to solve the above-described problems.

In addition, an object of the present disclosure is to provide a conductive film and a composite using the cation-intercalated MXene solution, or a MXene solution redispersed in a redispersion solvent.

In order to achieve the above-described objects of the present disclosure, the present disclosure discloses a cation-intercalated MXene comprising: MXene nanoparticles intercalated with a cation, wherein the MXene nanoparticles are representable in a MXene solution when dissolved in a solvent, wherein MXene nanoparticles of the MXene solution are represented by the following Chemical Formula 1,

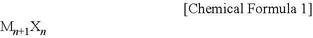

wherein,
M is a transition metal element selected from the group consisting of Sc, Ti, V, Cr, Mn,
Y, Zr, Nb, Mo, Hf, and Ta,
X is at least one of carbon and nitrogen, and
n is an integer of 1 to 4.

A concentration of the MXene solution is 0.01 mg/mL to 100 mg/mL, and a concentration of the cation is from 0.0000001 mol/L to 0.1 mol/L.

The cation includes at least one selected from the group consisting of a monovalent metal cation, a divalent metal cation, a trivalent metal cation, and an organic cation containing a nitrogen element.

The monovalent metal cation includes at least one selected from the group consisting of a Li ion, a Na ion, a K ion, a Rb ion, a Cs ion, and an Ag ion, the divalent metal cation includes at least one selected from the group consisting of a Mg ion, a Ca ion, a Co ion, a Ni ion, a Zn ion, a Cu ion, and a Sn ion, the trivalent metal cation includes at least one selected from the group consisting of an Al ion, an Fe ion, and a Cr ion, and the organic cation containing a nitrogen element includes at least one selected from an alkylammonium ion.

The cation-intercalated MXene is formed into a solid phase by drying the cation-intercalated MXene in a solution form.

The cation-intercalated MXene forms a redispersed MXene solution when the cation-intercalated MXene formed in a solid phase is dissolved in a redispersion solvent.

A concentration of the redispersed MXene solution is 0.01 mg/mL to 100 mg/mL.

The present invention discloses a method of manufacturing a cation-intercalated MXene solution, comprising adding a cation to a MXene solution, wherein MXene nanoparticles of the MXene solution are represented by the above Chemical Formula 1.

A concentration of the MXene solution is 0.01 mg/mL to 100 mg/mL, and a concentration of the cation is from 0.0000001 mol/L to 0.1 mol/L.

The cation includes at least one selected from the group consisting of a monovalent metal cation, a divalent metal cation, a trivalent metal cation, and an organic cation containing a nitrogen element.

The monovalent metal cation includes at least one selected from the group consisting of a Li ion, a Na ion, a K ion, a Rb ion, a Cs ion, and an Ag ion, the divalent metal cation includes at least one selected from the group consisting of a Mg ion, a Ca ion, a Co ion, a Ni ion, a Zn ion, a Cu ion, and a Sn ion, the trivalent metal cation includes at least one selected from the group consisting of an Al ion, an Fe ion, and a Cr ion, and the organic cation containing a nitrogen element includes at least one selected from an alkylammonium ion.

The method of manufacturing the cation-intercalated MXene further comprises drying the cation-intercalated MXene in a solution form so as to form a dried solid-phase cation-intercalated MXene.

In addition, the method of manufacturing the cation-intercalated MXene further comprises dissolving the dried solid-phase cation-intercalated MXene in a redispersion solvent so as to form a redispersed MXene solution.

A concentration of the redispersed MXene solution is 0.01 mg/mL to 100 mg/mL.

### BRIEF DESCRIPTION OF DRAWINGS

FIG. 1 is a conceptual diagram illustrating a cation-intercalated MXene solution, a solid-phase MXene obtained by drying the same, and a redispersed MXene solution obtained by dissolving the dried solid-phase MXene in a redispersion solvent, and a method of manufacturing the same, according to one embodiment of the present disclosure.

FIG. 2 is a photograph illustrating MXene redispersed at a high concentration in a solution according to one embodiment of the present disclosure.

FIG. 3 is a photograph illustrating MXene redispersed at a low concentration in a solution according to one embodiment of the present disclosure.

FIG. 4 is a photograph illustrating a MXene solution in which a monovalent metal cation, which is a Li ion, is intercalated according to a concentration of the Li ion, according to one embodiment of the present disclosure.

FIG. 5 is a photograph illustrating a MXene solution in which a divalent metal cation, which is a Mg ion, is intercalated according to a concentration of the Mg ion, according to one embodiment of the present disclosure.

FIG. 6 is a photograph illustrating a MXene solution in which a trivalent metal cation, which is an Al ion, is intercalated according to a concentration of the Al ion, according to one embodiment of the present disclosure.

FIG. 7 is a graph illustrating results of measuring absorbance of a redispersed MXene solution using a UV-vis absorption device after redispersing a freeze-dried solid-phase MXene in a solution, according to one embodiment of the present disclosure.

FIG. 8 is a graph illustrating redispersion ratios of PMX, T-LiMX, T-MgMX, and T-AlMX according to one embodiment of the present disclosure.

FIG. 9 is a photograph obtained by observing redispersed MXene particles with a microscope according to one embodiment of the present disclosure.

FIG. 10 is an XRD graph of a film measured after manufacturing a film using a redispersed MXene solution according to one embodiment of the present disclosure.

FIG. 11 is a graph illustrating electrical conductivity of a film measured after manufacturing a film using a redispersed MXene solution according to one embodiment of the present disclosure.

### DETAILED DESCRIPTION OF EMBODIMENTS

In the present specification, even in different embodiments, the same or similar reference numerals are assigned to the same or similar configurations, and duplicated descriptions thereof will be omitted.

In describing the embodiments disclosed in the present specification, when it is determined that a detailed description of related well-known technologies may obscure the gist of the embodiments disclosed in the present specification, the detailed description thereof will be omitted.

The accompanying drawings are provided only for easy understanding of the embodiments disclosed in the present specification, and the technical idea disclosed in the present specification is not limited by the accompanying drawings, and it should be understood that all modifications, equivalents, and substitutes included in the spirit and technical scope of the present disclosure are included.

In the following description, singular expressions include plural expressions unless the context clearly indicates otherwise.

In the present application, terms such as “include” or “have” are intended to designate that features, numbers, steps, operations, components, parts, or combinations thereof described in the specification are present, and are not intended to preclude in advance the presence or addition of one or more other features, numbers, steps, operations, components, parts, or combinations thereof.

Hereinafter, embodiments of a cation-intercalated MXene and a method of manufacturing the same according to the present disclosure will be described in detail with reference to the accompanying drawings.

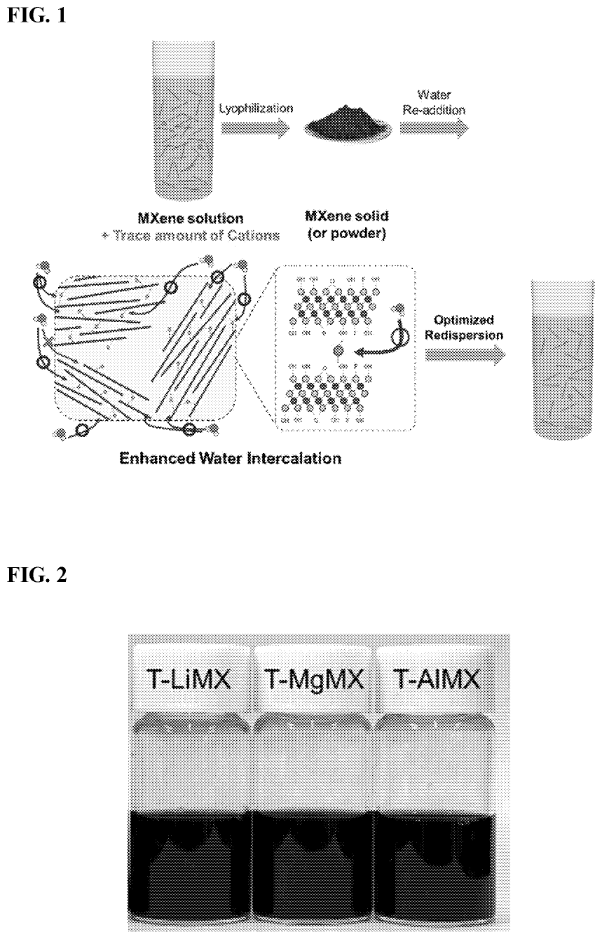

FIG. 1 is a conceptual diagram illustrating a cation-intercalated MXene solution, a solid-phase MXene obtained by drying the same, and a redispersed MXene solution obtained by dissolving the dried solid-phase MXene in a redispersion solvent, and a method of manufacturing the same, according to one embodiment of the present disclosure.

When a MXene solution in which a small amount of cations is intercalated is dried, a solid-phase MXene powder can be obtained. At this time, the small amount of cations prevents MXene nanoparticles from being strongly bonded to each other in the solution. When water is re-added to the dried MXene powder, bonding between the MXene particles and water molecules is not smooth. However, the small amount of cations bonded to the MXene particles bind with water molecules, and thus the MXene powder exhibits high redispersibility in a water solvent.

At this time, the long rod-shaped form shown in FIG. 1 schematically represents MXene particles, and the small circles bonded therebetween represent the intercalated cations. The lower left figure of FIG. 1 schematically illustrates that three circles having a water molecule shape do not directly bind to the MXene particles, but bind to cations between the MXene particles.

The lower right figure of FIG. 1 schematically illustrates a state in which, when water binds between MXene particles, the dried solid-phase MXene is smoothly redispersed in an aqueous solution.

The cation-intercalated MXene disclosed in the present invention includes MXene nanoparticles intercalated with a cation, wherein the MXene nanoparticles are implementable as a MXene solution when dissolved in a solvent, and wherein MXene nanoparticles of the MXene solution are represented by the following Chemical Formula 1.

The MXene used in a solvent redispersion method of MXene using cation intercalation according to one embodiment of the present disclosure is represented by the following Chemical Formula 1.

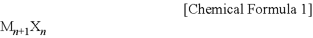

Herein, M is one or more transition metal elements selected from the group consisting of Sc, Ti, V, Cr, Mn, Y, Zr, Nb, Mo, Hf, and Ta, X is at least one of carbon and nitrogen, and n is an integer of 1 to 4.

When there are two transition metal elements, one of the transition metal elements may be represented as Ma, and the other transition metal element may be represented as Mb, and Chemical Formula 1 may be represented as (Ma_{(1-y)}Mb_{y})ₙ₊₁Xₙ.

Mₙ₊₁ may include, for example Ti₃, Nb₄, Mo₂, V₂, Cr₂, Sc₂, Mo₂Ti, Cr₂Ti, Nb₂Ti, TiNb, TiZr, and the like, but is not limited thereto.

The ion used in the cation-intercalated MXene and the method of manufacturing the same according to one embodiment of the present disclosure include at least one selected from the group consisting of a monovalent metal cation, a divalent metal cation, a trivalent metal cation, and an organic cation containing a nitrogen element.

The monovalent metal cation includes at least one selected from the group consisting of a Li ion, a Na ion, a K ion, a Rb ion, a Cs ion, and an Ag ion.

The divalent metal cation includes at least one selected from the group consisting of a Mg ion, a Ca ion, a Co ion, a Ni ion, a Zn ion, a Cu ion, and a Sn ion.

The trivalent metal cation includes at least one selected from the group consisting of an Al ion, an Fe ion, and a Cr ion.

The organic cation containing a nitrogen element may be an alkylammonium ion, and examples thereof include tetramethylammonium and tetrabutylammonium, but the organic cation is not limited thereto.

The cation added to the MXene solution may bind to MXene nanoparticles, and for example, the cation may bind to functional groups of the MXene nanoparticles, and the binding herein may mean all chemical bonds regardless of form or type.

MXene nanoparticles having functional groups may be represented as shown in the following Chemical Formula 2.

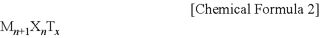

Herein, M is one or more transition metal elements, X is at least one of carbon and nitrogen, and n is an integer of 1 to 4, and Tx is a functional group and may be an element selected from the group consisting of H, O, F, and Cl, but is not necessarily limited thereto.

A method of manufacturing a cation-intercalated MXene according to an embodiment of the present invention comprises adding a cation to a MXene solution, wherein MXene nanoparticles of the MXene solution are represented by the above Chemical Formula 1.

A concentration of the MXene solution is 0.01 mg/mL to 100 mg/mL, and a concentration of the cation is from 0.0000001 mol/L to 0.1 mol/L.

The method of manufacturing the cation-intercalated MXene further comprises drying the cation-intercalated MXene in a solution form so as to form a dried solid-phase cation-intercalated MXene.

The method of manufacturing the cation-intercalated MXene further comprises dissolving the dried solid-phase cation-intercalated MXene in a redispersion solvent so as to form a redispersed MXene solution.

In the method of manufacturing the cation-intercalated MXene, a concentration of the redispersed MXene solution is 0.01 mg/mL to 100 mg/mL.

Hereinafter, a solvent redispersion method of MXene using ion intercalation according to one embodiment of the present disclosure will be described in detail with reference to FIG. 1.

### Embodiment 1

1. A small amount of cations is added to a MXene solution. At this time, a concentration range of the MXene solution is 0.01 mg/mL to 100 mg/mL, and a concentration range of the added cations is 0.0000001 mol/L to 0.1 mol/L. Depending on a type of the cation, an optimal concentration range in which the MXene solution can be dispersed may be different.
2. The MXene solution to which a small amount of cations is added in step 1 is freeze-dried to obtain MXene in a solid form such as a powder. Accordingly, the cation-intercalated MXene is dried from a solution form to obtain a solid-phase cation-intercalated MXene.
3. The MXene in the solid form obtained in step 2 is added again to a solution to obtain MXene redispersed in the solution. At this time, a concentration of the redispersed MXene solution is 0.01 mg/mL to 100 mg/mL. Concentrations outside the above range may also be used, but concentrations within the above range are generally used. Accordingly, the solid-phase cation-intercalated MXene is dissolved in a redispersion solvent to form a redispersed MXene solution.

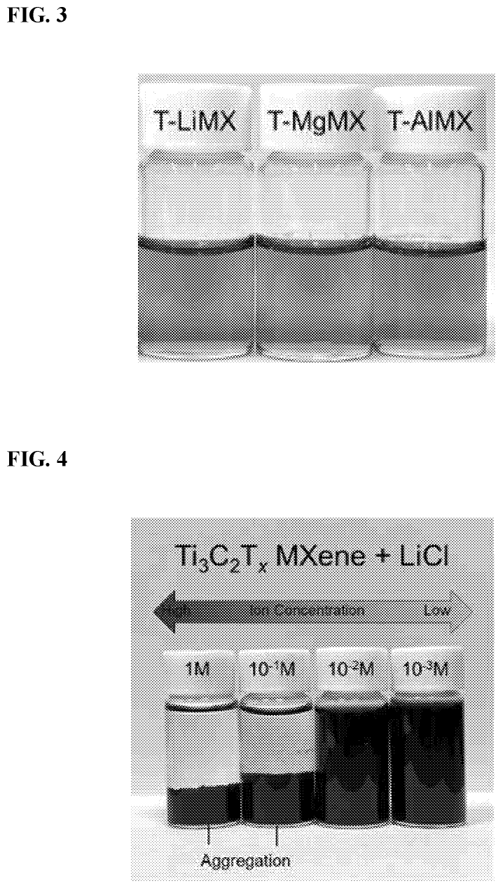

FIG. 2 is a photograph illustrating MXene redispersed at a high concentration in a solution according to one embodiment of the present disclosure, and FIG. 3 is a photograph illustrating MXene redispersed at a low concentration in a solution according to one embodiment of the present disclosure.

In FIG. 2, a concentration of the MXene solution is about 10 mg/mL, and at this time, concentrations of the added cations are respectively 0.01 mol/L for Li ions, 0.0001 mol/L for Mg ions, and 0.0001 mol/L for Al ions. The MXene solutions in which the Li ions, Mg ions, and Al ions are intercalated are evenly redispersed without aggregation.

In FIG. 3, a concentration of the MXene solution is about 0.01 mg/mL, and at this time, concentrations of the added cations are respectively 0.01 mol/L for Li ions, 0.0001 mol/L for Mg ions, and 0.0001 mol/L for Al ions. The MXene solutions in which the Li ions, Mg ions, and Al ions are intercalated are evenly redispersed without aggregation.

FIGS. 4 to 6 are photographs illustrating MXene solutions to which ions having various valences are added.

FIG. 4 is a photograph illustrating a MXene solution in which a monovalent metal cation, which is a Li ion, is intercalated according to a concentration of the Li ion, according to one embodiment of the present disclosure.

Concentrations of the Li ions are respectively 1 M, 10⁻¹ M, 10⁻² M, and 10⁻³ M. At this time, when the concentration of the Li ions is 1 M to 10⁻¹ M, MXene particles aggregate and redispersion does not occur evenly in the solution. On the other hand, when the concentration of the Li ions is 10-2 M to 10⁻³ M, MXene particles do not aggregate and are evenly redispersed in the solution.

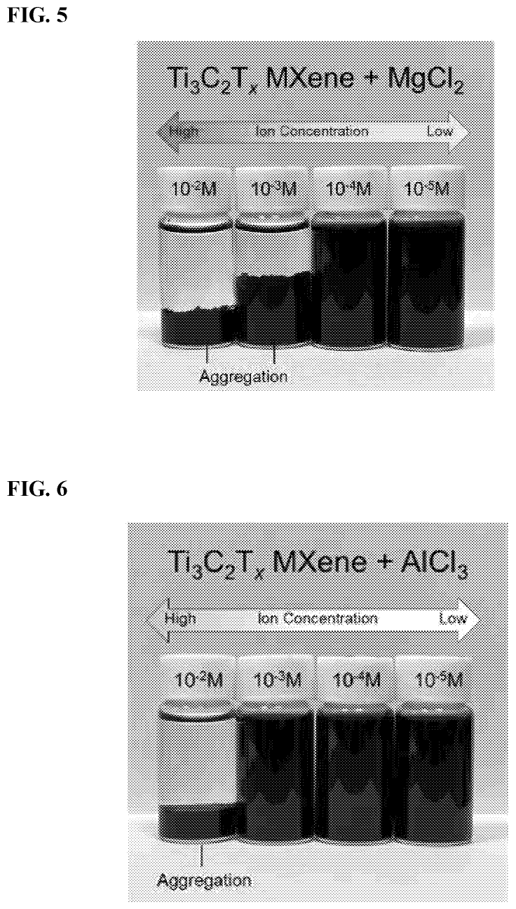

FIG. 5 is a photograph illustrating a MXene solution in which a divalent metal cation, which is a Mg ion, is intercalated according to a concentration of the Mg ion, according to one embodiment of the present disclosure.

Concentrations of the Mg ions are respectively 10⁻² M, 10⁻³ M, 10⁻⁴ M, and 10⁻⁵ M. At this time, when the concentration of the Mg ions is 10⁻² M to 10⁻³ M, MXene particles aggregate and redispersion does not occur evenly in the solution. On the other hand, when the concentration of the Mg ions is 10⁻⁴ M to 10⁻⁵ M, MXene particles do not aggregate and are evenly redispersed in the solution.

FIG. 6 is a photograph illustrating a MXene solution in which a trivalent metal cation, which is an Al ion, is intercalated according to a concentration of the Al ion, according to one embodiment of the present disclosure.

Concentrations of the Al ions are respectively 10⁻² M, 10⁻³ M, 10⁻⁴ M, and 10⁻⁵ M. At this time, when the concentration of the Al ions is 10⁻² M, MXene particles aggregate and redispersion does not occur evenly in the solution. On the other hand, when the concentration of the Mg ions is 10⁻³ M to 10⁻⁵ M, MXene particles do not aggregate and are evenly redispersed in the solution.

Through the above experimental results, it can be confirmed that redispersion occurs better as a relatively smaller amount of cations is intercalated in the MXene solution.

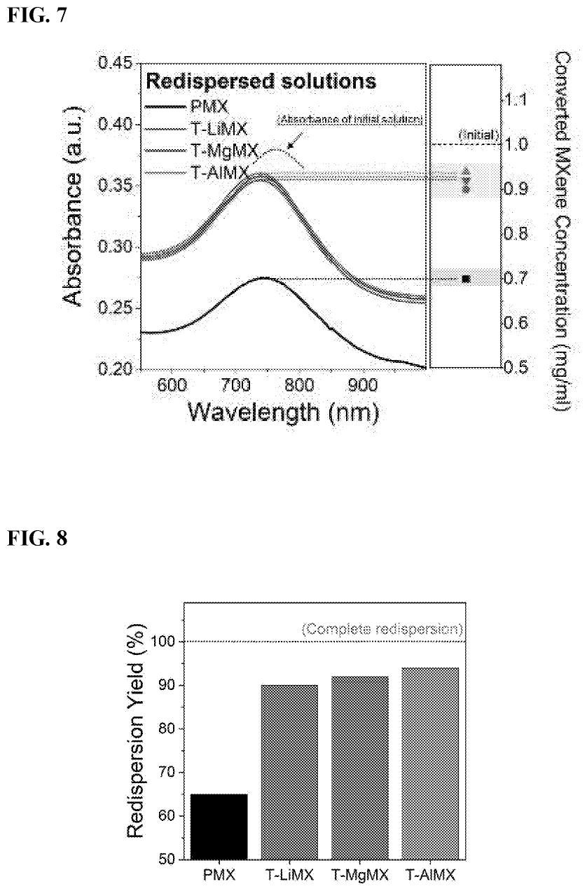

FIGS. 7 to 8 are graphs illustrating redispersion characteristics when a solid-phase MXene generated by freeze-drying a cation-intercalated MXene solution is redispersed in a solution, according to one embodiment of the present disclosure.

FIG. 7 is a graph illustrating results of measuring absorbance of a redispersed MXene solution using a UV-vis absorption device after redispersing a freeze-dried solid-phase MXene in a solution, according to one embodiment of the present disclosure.

At this time, PMX represents general MXene to which no cation is added, T-LiMX represents Li ion-intercalated MXene, T-MgMX represents Mg ion-intercalated MXene, and T-AlMX represents Al ion-intercalated MXene.

An absorption region of 700-800 nm shown in FIG. 7 is a characteristic absorption region appearing in MXene having a Ti₃C₂Tₓ composition.

Since absorbance of the absorption region is proportional to a concentration of MXene contained in a solution, the absorbance can be utilized as an indicator capable of quantitatively calculating a concentration of MXene dispersed in the solution.

As shown in FIG. 7, since absorbance values of T-LiMX, T-MgMX, and T-AlMX are higher than absorbance of PMX, it can be seen that T-LiMX, T-MgMX, and T-AlMX have higher redispersion efficiency than PMX.

In addition, by utilizing a conversion factor according to an absorbance-concentration correlation, a maximum absorbance value can be converted into a MXene solution concentration, and this is illustrated in a right graph of FIG. 7.

FIG. 8 is a graph illustrating redispersion ratios of PMX, T-LiMX, T-MgMX, and T-AlMX according to one embodiment of the present disclosure.

The redispersion ratio is calculated by comparing a ratio of absorbance of a MXene solution before redispersion and absorbance of a MXene solution after redispersion.

When a general MXene material (PMX) to which a metal cation is not added is used, a redispersion ratio of a solution after freeze-drying is about 60%.

On the other hand, in the case of MXene materials (T-LiMX, T-MgMX, and T-AlMX) to which metal cations are added, a redispersion ratio of a solution after freeze-drying exceeds 90%, and thus exhibits a significantly higher redispersion ratio than the general MXene material (PMX).

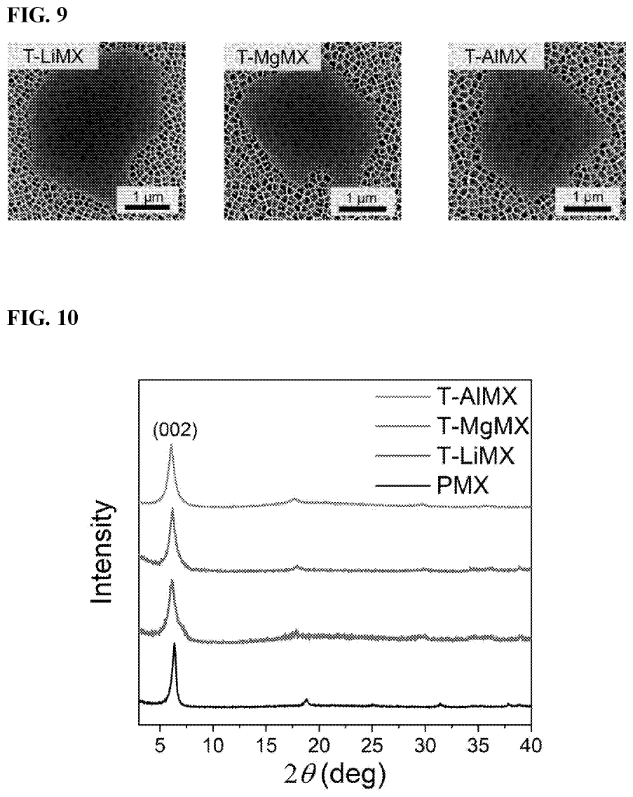

FIG. 9 is a photograph obtained by observing redispersed MXene particles with a microscope according to one embodiment of the present disclosure.

When individual particles of a redispersed MXene solution generated by redispersing a solid-phase MXene produced by freeze-drying MXene solutions respectively intercalated with Li ions, Mg ions, and Al ions are observed with a microscope, it is confirmed that single sheets exist in a form in which they are separately dispersed without being agglomerated.

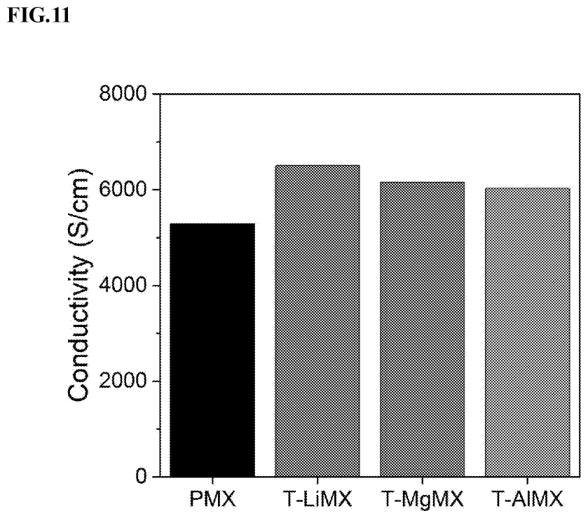

FIGS. 10 to 11 are graphs illustrating structural characteristics and electrical characteristics after manufacturing a film using a redispersed MXene solution according to one embodiment of the present disclosure.

FIG. 10 is an XRD graph of a film measured after manufacturing a film using a redispersed MXene solution according to one embodiment of the present disclosure.

The MXene redispersed in a solvent after being intercalated with Li ions, Mg ions, and Al ions are respectively T-LiMX, T-MgMX, and T-AlMX.

At this time, T-LiMX, T-MgMX, and T-AlMX exhibit a clear (002) peak similarly to PMX, which is a general MXene. Accordingly, it is demonstrated that the redispersed MXenes T-LiMX, T-MgMX, and T-AlMX are films having high particle alignment.

FIG. 11 is a graph illustrating electrical conductivity of a film measured after manufacturing a film using a redispersed MXene solution according to one embodiment of the present disclosure.

The MXene redispersed in a solvent after being intercalated with Li ions, Mg ions, and Al ions are respectively T-LiMX, T-MgMX, and T-AIMX.

Electrical conductivity of PMX, which is a general MXene, is about 5000 S/cm, electrical conductivity of T-LiMX is about 7000 S/cm, and electrical conductivities of T-MgMX and T-AlMX are about 6000 S/cm.

It is confirmed that MXene films intercalated with cations exhibit higher electrical conductivity and thus have superior performance compared to general MXene films to which cations are not intercalated.

The above-described contents are merely illustrative, and various modifications may be made by a person having ordinary skill in the art to which the present disclosure pertains without departing from the scope and technical idea of the described embodiments, and the embodiments described above may be implemented individually or in any combination.

The effects of the present disclosure obtained through the above-described solutions are as follows.

The cation-intercalated MXene solution proposed in the present disclosure prevents MXene nanoparticles from being strongly bonded.

In addition, the cation-intercalated MXene solution proposed in the present disclosure can be stably redispersed in a solvent even after being dried.

In addition, a film manufactured from a redispersion solution of a solid-phase MXene obtained by drying the cation-intercalated MXene solution proposed in the present disclosure has high particle alignment.

In addition, a film manufactured from a redispersion solution of a solid-phase MXene obtained by drying the cation-intercalated MXene solution proposed in the present disclosure has high electrical conductivity.

The cation-intercalated MXene proposed in the present disclosure can be customized and utilized in various industrial fields due to high redispersibility.

The present disclosure can be utilized in industrial fields related to MXene or applications of MXene.

What is claimed is:

1. A cation-intercalated MXene, comprising:
MXene nanoparticles intercalated with a cation,
wherein the MXene nanoparticles are representable in a MXene solution when dissolved in a solvent,
wherein MXene nanoparticles of the MXene solution are represented by the following Chemical Formula 1, 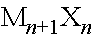
wherein,
M is one or more transition metal elements selected from the group consisting of Sc, Ti, V, Cr, Mn, Y, Zr, Nb, Mo, Hf, and Ta,
X is at least one of carbon and nitrogen, and
n is an integer of 1 to 4.

2. The cation-intercalated MXene according to claim 1, wherein a concentration of the MXene solution is 0.01 mg/mL to 100 mg/mL, and a concentration of the cation is from 0.0000001 mol/L to 0.1 mol/L.

3. The cation-intercalated MXene according to claim 1, wherein the cation includes at least one selected from the group consisting of a monovalent metal cation, a divalent metal cation, a trivalent metal cation, and an organic cation containing a nitrogen element.

4. The cation-intercalated MXene according to claim 3, wherein
the monovalent metal cation includes at least one selected from the group consisting of a Li ion, a Na ion, a K ion, a Rb ion, a Cs ion, and an Ag ion,
the divalent metal cation includes at least one selected from the group consisting of a Mg ion, a Ca ion, a Co ion, a Ni ion, a Zn ion, a Cu ion, and a Sn ion,
the trivalent metal cation includes at least one selected from the group consisting of an Al ion, an Fe ion, and a Cr ion, and
the organic cation containing a nitrogen element includes at least one selected from an alkylammonium ion.

5. The cation-intercalated MXene according to claim 1, wherein the cation-intercalated MXene is formed into a solid phase by drying the cation-intercalated MXene in a solution form.

6. The cation-intercalated MXene according to claim 5, wherein the cation-intercalated MXene forms a redispersed MXene solution when the cation-intercalated MXene formed in a solid phase is dissolved in a redispersion solvent.

7. The cation-intercalated MXene according to claim 6, wherein a concentration of the redispersed MXene solution is 0.01 mg/mL to 100 mg/mL.

8. A method of manufacturing a cation-intercalated MXene, comprising:
adding a cation to a MXene solution,
wherein MXene nanoparticles of the MXene solution are represented by the following Chemical Formula 1. 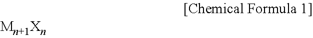
wherein,
M is one or more transition metal elements selected from the group consisting of Sc, Ti, V, Cr, Mn, Y, Zr, Nb, Mo, Hf, and Ta,
X is at least one of carbon and nitrogen, and
n is an integer of 1 to 4.

9. The method of manufacturing a cation-intercalated MXene according to claim 8, wherein a concentration of the MXene solution is 0.01 mg/mL to 100 mg/mL, and a concentration of the cation is from 0.0000001 mol/L to 0.1 mol/L.

10. The method of manufacturing a cation-intercalated MXene according to claim 8, wherein the cation includes at least one selected from the group consisting of a monovalent metal cation, a divalent metal cation, a trivalent metal cation, and an organic cation containing a nitrogen element.

11. The method of manufacturing a cation-intercalated MXene according to claim 10, wherein
the monovalent metal cation includes at least one selected from the group consisting of a Li ion, a Na ion, a K ion, a Rb ion, a Cs ion, and an Ag ion,
the divalent metal cation includes at least one selected from the group consisting of a Mg ion, a Ca ion, a Co ion, a Ni ion, a Zn ion, a Cu ion, and a Sn ion,
the trivalent metal cation includes at least one selected from the group consisting of an Al ion, an Fe ion, and a Cr ion, and
the organic cation containing a nitrogen element includes at least one selected from an alkylammonium ion.

12. The method of manufacturing a cation-intercalated MXene according to claim 8, further comprising:
drying the cation-intercalated MXene in a solution form so as to form a dried solid-phase cation-intercalated MXene.

13. The method of manufacturing a cation-intercalated MXene according to claim 12, further comprising:
dissolving the dried solid-phase cation-intercalated MXene in a redispersion solvent so as to form a redispersed MXene solution.

14. The method of manufacturing a cation-intercalated MXene according to claim 13, wherein a concentration of the redispersed MXene solution is 0.01 mg/mL to 100 mg/mL.
